(19) United States
(12) Patent Application Publication
(10) Pub. No.: US 2015/0020393 A1
(43) Pub. Date: Jan. 22, 2015

(54) Thread Identification Kit

(71) Applicant: Henry Y. Shallcross, Arlington, TX (US)

(72) Inventor: Henry Y. Shallcross, Arlington, TX (US)

(21) Appl. No.: 13/947,064

(22) Filed: Jul. 21, 2013

(51) Int. Cl. G01B 5/20

(52) U.S. Cl. CPC G01B 5/204; G01B 2210/60
USPC 33/199 R

(57) ABSTRACT

The invention is a fitting identification kit that includes a set of short aluminum fitting gages with male threads on one end, female threads on the other, a knurled surface to allow ease of handling, and a milled flat surface on the exterior where the thread size of each fitting gages is engraved. The kit fits in one side of a carrier, which has a location diagram fixed on the other side of the carrier showing the location and sizes of the fitting gages as they sit in the carrier, held in place by the placement foam.

### TECHNICAL FIELD OF THE INVENTION

The present disclosure relates generally to hose fittings and related measurement devices.

### BACKGROUND OF THE INVENTION

Pneumatic hose and pipe screw threads can be defined by many different specifications. The invention disclosed in this application concerns itself with British Standard Pipe, Parallel (“BSPP” or “BPP”), and Metric threads, both of which are “straight” or “parallel” threads, in which the threads have a constant diameter.

BPP has a threadform following the British Standard Whitworth standard. Metric threads in this application are defined by ISO 9974-1, but the invention is not limited to this specification.

The number of types of threads can be daunting, as many of them have only slight differences. For example, the BPP connection is similar to National Pipe Straight Mechanical (NPSM), except the thread pitches differ in many sizes. While many users mistakenly identify BPP fittings as metric, these fittings are actually measured in inches. Some Japanese (JIS 30°) fittings also use BSPP thread.

Because of these slight differences, even those with substantial experience in the field can find themselves with pipes and hoses with unknown fittings and threads. As these threads can be easily damaged, those who seek to repair or replace a fitting must avoid attempting to attach devices with differing threads.

Many types of commercially available devices and techniques are used to determine pipe threads. One common approach is to use a set of fitting keys, each key constructed with one or more flat surfaces, where each flat edge has a jagged edge that matches a single thread type. The user attempts to determine which of the keys has an edge that is shaped to match an unknown thread, and then measure the outside diameter of the pipe. The thread and pipe diameter specifications are sufficient to identify the fitting.

Another common measurement technique is to just use a pipe with a known pipe thread and see if it marries to the unknown fitting. This approach has the negative aspect that the fittings, hose, and piping combinations are heavy. To be useful, they have to be clearly marked, easily hand-manipulated, and be light-weight for ease of mobility.

Salesmen in the business of finding solutions for those who purchase fittings often need to test the products in a potential client's possession which have an unknown threading. They need a rugged lightweight set of pipe identification instruments.

### SUMMARY OF THE INVENTION

The present disclosure provides a Fitting Identification Kit 11 that includes a set of short aluminum Fitting Gages 13 with Male Threads 15 on one end, Female Threads 17 on the other, a Knurled Surface 19 to allow ease of handling, and a milled Flat Surface 21 on the exterior where the Thread Size 23 of each Fitting Gages 13 is engraved. The Kit 11 fits in one side of a Carrier 25, which has a Location Diagram 29 fixed on the other side (typically the lid) of the Carrier 25 showing the location and sizes of the Fitting Gages as they sit in the Carrier 25, held in place by the Placement Foam 27.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts a front view of one of the kit's Fitting Gages 13, without hidden lines.

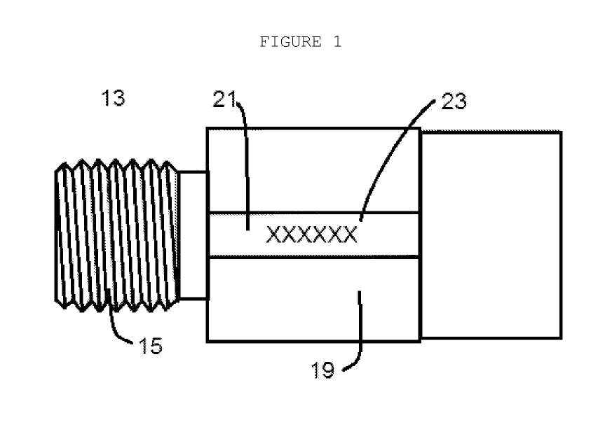

FIG. 2 depicts a front view of the Fitting Gage 13 in FIG. 1, showing hidden lines.

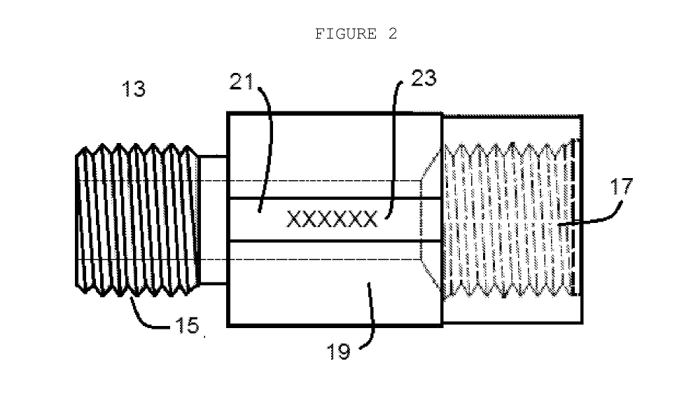

FIG. 3 depicts a front view of a cross section of the Fitting Gage 13 in FIG. 1 and FIG. 2, in which the section is taken along any plane that includes the axis of the fitting.

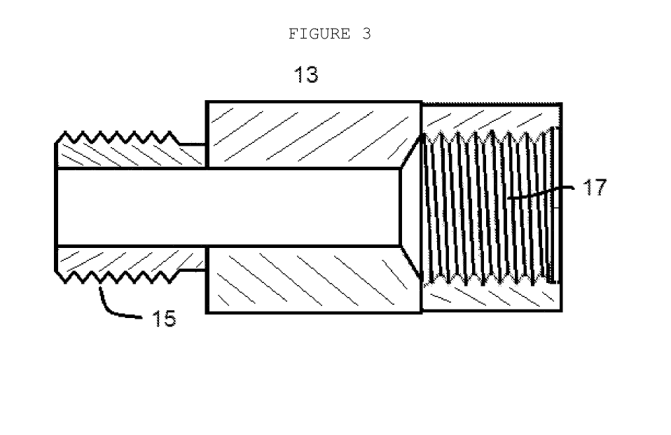

FIG. 4 depicts a front view of the Kit 11, placed in the Carrier 25.

### DETAILED DESCRIPTION OF THE INVENTION

While the making and using of various embodiments of the present disclosure are discussed in detail below, it should be appreciated that the present disclosure provides several inventive concepts that can be embodied in a wide variety of specific contexts. The disclosure is primarily described and illustrated hereinafter in conjunction with a particular embodiment of the presently-described Fitting Identification Kit 11. The specific embodiment discussed herein is, however, merely illustrative of specific ways to make and use the disclosure and do not limit the scope of the disclosure.

The figures depict a representative identification Fitting 13, which is a part of a Fitting Identification Kit 11 in which each fitting is useful to identify one particular fitting thread. In the embodiment as currently sold, the Fitting Gages 13 range from BPP ⅛-28 to 2-11 and metric M8×1.0 to M52×2.0.

Though the set is not limited to this list, the Kit 11 as comprised includes the following BPP and metric Fitting Gages 13:

BPP: ⅛-28, ¼-19, ⅜-19, ½-14, ⅝-14, ¾-14, 1-11, 1¼-11, 1½-11, 2-11; and Metric M8×1.0, M10×1.0, M12×1.5, M14×1.5, M16×1.5, M18×1.5, M20×1.5, M22×1.5, M24×1.5, M26×1.5, M27×1.5, M30×1.5, M30×2.0, M33×2.0, M36×2.0, M38×1.5, M42×2.0, M45×1.5, M45×2.0, M52×2.0.

Though service personnel often struggle to identify a specific thread, personnel can often look at the rest of a system being repaired and determine that it is composed of either BPP fittings or metric fittings. To further assist in the identification of a specific thread, the Fitting Gages 13 in the Kit 11 are colored one color, and those with metric threads are colored another.

In the specific embodiment as currently composed, the metric Fitting Gages 13 are bright green, and the BPP Fitting Gages 13 are red. Because some manufacturers of piping products consistently use one set of threads that are known to those in the industry. In such a way, anyone servicing these fittings can eliminate an entire set of potential threads by identifying whether the system uses BPP or metric fittings.

Pipe fittings are typically made of iron or brass, two very heavy metals. The fittings in this set are made of aluminum, a metal not normally used to create these parts due to difficulty and cost of working with aluminum. But in an identification kit, these fittings have the advantage that a salesman has a far less heavy burden while traveling from one office or another, or for less strong sales people working in an office who must lift the kit regularly to a counter.

Similarly, the central portion of the Fitting 13, situated between the fittings is treated with a Knurled Surface 19. This treatment also separates the Fittings 13 from a simple cut pipe used for identification purposes. Fittings can be in a tight space where handling is difficult; the Knurled Surface 19 eases use of a Fitting 13 in areas where a user has little room to maneuver.

Lastly, the identification fittings include a milled Flat Surface 21 on the exterior of each Fitting 13, on which is the Thread Size of the fitting is clearly engraved. On the Fitting Gages 13 as currently manufactured, this milled Flat Surface appears as a 0.26″ chord cut across the part of the Fitting Gage 13 with the widest diameter on the current embodiment, but it could be anywhere on the Fitting Gage 13.

The milled Flat Surface 21 with engraved Thread Size 23 is an improvement over the simple practice of marking a pipe or fitting with a permanent marker or even an engraving on the round fitting, as the milled Flat Surface 21 protects the engraved Thread Size 23 from damage over time as the Fitting Gages 13 are handled over time. One in the industry that finds himself identifying unknown threads with a Fitting Gage 13 will handle the Fitting Gages 13 far more often than one in the industry will handle a fitting that will be installed, so the additional construction details ensure that the Thread Size 23 is not worn away as it would be by continuous use if a simple short length of pipe was threaded and used for this purpose. In short, this construction is useful for a gage, but not for typical fittings that will be installed or used and placed under pressure.

The inventor will also point out that the milled Flat Surface 21 is a construction that is at odds with the construction of piping and fittings designed to be used under pressure, as the milling process necessarily removes material from the fitting, making it weaker and less able to maintain industry pressure for any given pipe than pipe which is not so milled.

The inventor will also point out that that an alternative construction could include a flat surface created on a fitting by constructing a raised flat surface on the round fitting. This manufacture fits within the ambit of the invention, but is inferior to the milled surface, as a raised surface requires a more complex aluminum construction and creates a point on the fitting that might prevent rotation of the fitting onto a pipe.

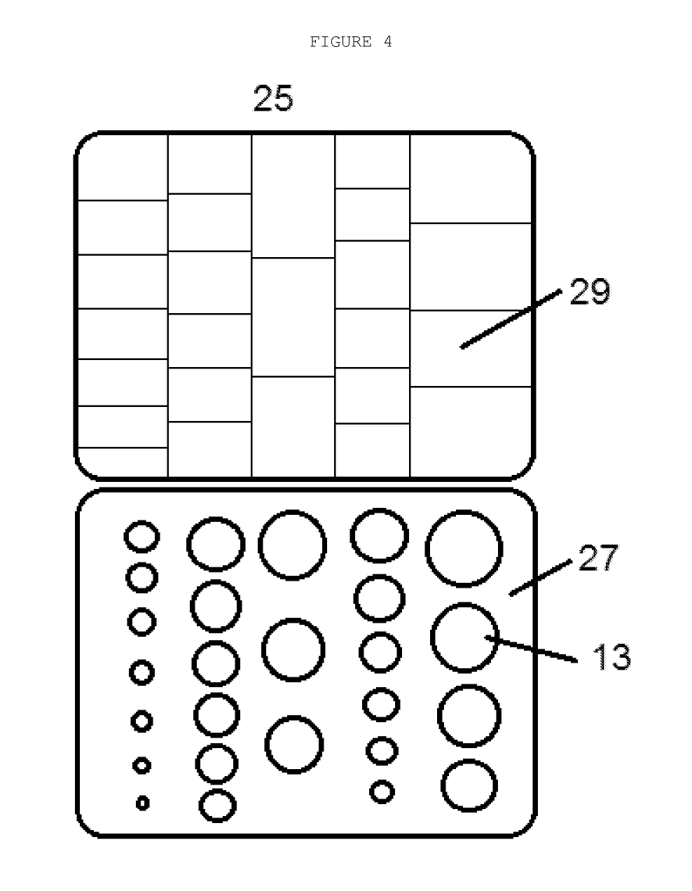

As shown in FIG. 4, the Fitting Gages 13 are placed in a foam-lined luggage Carrier 25 so a salesman can carry them with ease. When the Carrier 25 is opened, the lid of the Carrier 25 opens to show a Location Diagram 29 of the Fitting Gages 13 as they are located in the base of the Carrier 25. Each rectangular space in the Location Diagram has lettering in it to indicate the thread of the corresponding Gage 13 in the Carrier's base.

Each Fitting Gage 13 has a specific matching location in the Carrier 25, held there by Placement Foam 27, which sits in the base of the Carrier 25. The Placement Foam 27 has a void for each Fitting Gage 13 sized and located so each Gage 13 fits snugly in one place in the Carrier 25, corresponding with the Location Diagram in the lid of the Carrier.

All embodiments described herein are presented for purposes of illustration and explanation only. These descriptions of one embodiment are not intended to be limiting to the embodiments described. Those skilled in the relevant art will be able to create other embodiments based on this disclosure and the claims that are attached with this application.

The inventor claims:

1. An identification thread fitting gage comprising:
a. A length of aluminum pipe;
b. a first end of the aforementioned pipe, comprising a male thread;
c. a second end of the aforementioned pipe, opposite of the first end, comprising a female thread that matches the same thread of the first end; and,
d. an engraved marking on the exterior of the pipe identifying the thread employed on the two ends of the pipe using industry-accepted nomenclature.

2. An identification thread fitting gage as in claim 1, in which the thread size of the fitting is engraved on a flat surface milled onto the exterior of the fitting gage.

3. An identification thread fitting gage as in claim 1, in which the thread size of the fitting is engraved on a flat raised surface on the exterior of the fitting gage.

4. An identification thread fitting kit comprising a series of identification thread fitting gages as described in claim 1, with the threads varying in size to reflect those defined in a single or multiple industry standards.

5. An identification thread fitting kit comprising a series of identification thread fitting gages as described in claim 1, with the threads varying in size to reflect those defined in a single or multiple industry standards.

6. An identification thread fitting kit as in claim 5 in which the set of thread fitting gages include commonly used threads defined by the “British Standard Pipe, Parallel” (“BSPP” or “BPP”) or “Metric”.

7. An identification thread fitting kit as described in claim 6, in which the identification thread fitting gages in the kit that identify a fitting thread belonging to a specific industry standard are all similarly color-coded, with each industry standard coded with a color different from the thread gages defining threads of a different industry standard.

8. An identification thread fitting kit as described in claim 7, in which the identification thread fitting gages that identify threads defined by the industry standard recognized as “British Standard Pipe, Parallel” (“BSPP” or “BPP”) have an exterior of one color, different from the color of other thread fittings in the kit which define threads not belonging to the BPP standard.

9. An identification thread fitting kit as described in claim 7, in which the identification thread fitting gages that identify threads defined by the industry standard recognized as “Metric” have an anodized exterior of one color, different from the color of other thread fitting gages in the kit which define threads not belonging to the Metric standard.

10. An identification thread fitting kit as described in claim 7, in which metric threads included are taken from the list: M8×1.0, M10×1.0, M12×1.5, M14×1.5, M16×1.5, M18×1.5, M20×1.5,and M22×1.5, M24×1.5, M26×1.5, M27×2.0, M30×1.5, M30×2.0, M33×2.0, M36×1.5, M36×2.0, M38×1.5, M42×2.0, M45×1.5, M45×2.0, and M52×2.0; and the BPP threads included are taken from the list: 1-16-28, ⅛-28, ¼-19, ⅜-19, ½-14, ⅝-14, ¾-14, 1-11, 1¼-11, 1½-11, 2-11, 2½-11, 3-11, 4-11, 5-11, and 6-11.

11. A Kit 11 as claim 4, in which the fitting gages are placed in a foam-lined luggage carrier, including a diagram of locations for the fitting gages as they are located in the base of the carrier, each fitting gage fitting in a specific location in the carrier, and in which each fitting gage is held in position in the carrier by foam which sits in the base of the carrier, and has a specific void in which each fitting gage in the kit fits snugly.
